(19) United States
(12) Patent Application Publication
(10) Pub. No.: US 2017/0124248 A1
(43) Pub. Date: May 4, 2017

(54) COMPUTER AIDED PIPE STRING DESIGN BASED ON EXISTING STRING DESIGNS

(71) Applicant: Landmark Graphics Corporation, Houston, TX (US)

(72) Inventors: Andrew J. Whalley, Calgary (CA); Ron Vutpakdi, Missouri, TX (US); Gustavo A. Urdaneta, Houston, TX (US)

(73) Assignee: Landmark Graphics Corporation, Houston, TX (US)

(21) Appl. No.: 15/319,735

(22) PCT Filed: Aug. 22, 2014
(86) PCT No.: PCT/US2014/052357

§ 371 Date: Dec. 16, 2016

(51) Int. Cl. G06F 17/50; E21B 17/00; E21B 41/00

(52) U.S. Cl. CPC G06F 17/5086; E21B 41/0092; E21B 17/00; G06F 2217/02; G06F 2217/34

(57) ABSTRACT

Systems and methods for computer aided pipe string design based on existing string designs are provided. A string type for a current string design is determined based on input received from a user via a graphical user interface (GUI). The GUI enables the user to create the current string design within a graphical design area of the GUI using string components selected from a component selection area of the GUI. A components list is generated based one component data associated with the previously created string designs and a set of component properties that uniquely identify individual components of the previously created string designs. The generated list of components is filtered based on one or more filtering parameters related to the current string design and the previously created string designs. The filtered list for a selected component category is displayed within the component selection area of the GUI.

### FIELD OF THE DISCLOSURE

The present disclosure relates generally to the field of computer aided design applications and, more particularly, to computer aided design applications for pipe string assemblies used in the exploration and recovery of subsurface hydrocarbon deposits.

### BACKGROUND

In the exploration and recovery of subsurface hydrocarbon deposits, such as oil and natural gas, a borehole is typically drilled with a rotatable drill bit that is attached to an end of a bottom hole assembly or “BHA.” The borehole may be drilled in a vertical or horizontal direction using a boring device that pushes or steers a series of connected drill pipes with a steerable drill bit at the distal end to achieve the borehole geometry. A steerable BHA can include, for example, a positive displacement motor (PDM) or “mud motor,” drill collars, reamers, shocks, and underreaming tools to enlarge the wellbore. A stabilizer may be attached to the BHA to control the bending of the BHA to direct the bit in the desired direction (inclination and azimuth). The BHA, in turn, is attached to the bottom of a tubing assembly, often comprising jointed pipe or relatively flexible tubing, also known as “coiled tubing.” Such a directional drilling system, including the operatively interconnected tubing, drill bit, and BHA, may be referred to as a “drill string.” In addition to drill strings, other types of strings are used in the field of hydrocarbon exploration and recovery for a variety of purposes. Examples of such “pipe strings” or “pipe string assemblies” include, but are not limited to, well completion strings, rod strings and workover strings.

Advances in computer aided design tools have allowed petroleum engineers to automate the pipe string design process. Such tools enable users to virtually connect different types of components for a desired pipe string assembly. The components for a particular string design may be selected from various catalogs published by component manufacturers or other industry service providers. However, string design using conventional tools generally involves manually searching through large component catalogs to find particular components and inputting the data for each selected component individually. Thus, string design using conventional design tools can be a very tedious and time consuming process that decreases productivity and degrades user experience.

### BRIEF DESCRIPTION OF THE DRAWINGS

FIG. 1 illustrates a block diagram of an exemplary computer system for aiding pipe string design based on existing string designs, according to an embodiment of the present disclosure.

FIGS. 2A, 2B and 2C illustrate different views of an exemplary graphical user interface (GUI) for designing pipe strings based on existing string designs, according to an embodiment.

FIG. 3 illustrates an exemplary user process for filtering a component catalog by selecting particular component properties within a panel of the GUI of FIG. 2A.

FIG. 4 is a process flowchart of an exemplary method for filtering string components for a pipe string design based on existing string designs.

FIG. 5 is a block diagram of an exemplary computer system in which embodiments may be implemented.

### DESCRIPTION OF ILLUSTRATIVE EMBODIMENTS

Illustrative embodiments and related methodologies of the present disclosure are described below as they might be employed in a computer system for aiding pipe string design based on existing string designs. While the present disclosure is described herein with reference to illustrative embodiments for particular applications, it should be understood that embodiments are not limited thereto. Other embodiments are possible, and modifications can be made to the embodiments within the spirit and scope of the teachings herein and additional fields in which the embodiments would be of significant utility.

In the interest of clarity, not all features of an actual implementation or methodology are described in this specification. It will be appreciated that in the development of any such actual implementation, numerous implementation-specific decisions must be made to achieve the developers' specific goals, such as compliance with system-related and business-related constraints, which will vary from one implementation to another. Further, when a particular feature, structure, or characteristic is described in connection with an embodiment, it is submitted that it would be within the knowledge of one skilled in the relevant art to effect such feature, structure, or characteristic in connection with other embodiments whether or not explicitly described.

Also, it would be apparent to one skilled in the relevant art that the embodiments of the present disclosure can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein. Further aspects and advantages of the various embodiments and related methodologies of this disclosure will become apparent from consideration of the following description and drawings.

As will be described in further detail below, embodiments of the present disclosure provide a capability to assist users in designing various types of pipe string assemblies based on existing string designs. Such “existing” string designs may include previously created string designs in addition to a current string design being created by, for example, a user of a string design editor application. In one example, the string design editor application includes a graphical user interface (GUI) that enables the user to create a graphical representation of a string design within a design area of the GUI by using a drag and drop interface to select string components directly from a component selection area of the GUI and add (or “drop”) each selected component into the design area. The term “string component” (or simply, “component”) is used herein to refer to an individual item or unit of hardware included within a section of a pipe string assembly. In an embodiment, a component may be identified by a pair of identifiers or codes corresponding to a component category (also referred to herein as a “section type”) and a component type associated with the component, as will be described in further detail below. The GUI also may provide an automated or “intelligent” filtering feature that presents the user with only the most relevant components or those determined to have the greatest likelihood of being selected by the user. The determination may be based on, for example, various filtering parameters related to characteristics of the current string design being created and prior component selections associated with previously created string designs. Examples of such filtering parameters may include, but are not limited to, component popularity based on historical data (e.g., components most often used in previously created string designs), physical constraints of the particular well site or borehole (e.g., hole diameter), component availability based on particular geographic location of well site and potential use of the string, and other user-specific or design-specific parameters.

Advantages of the intelligent filtering techniques disclosed herein include increasing user productivity by reducing the time and complexity of designing an assembly string. Further, the disclosed techniques improve user experience for string design applications by providing an interactive visual interface that simplifies the selection and data entry of appropriate components for a desired string design.

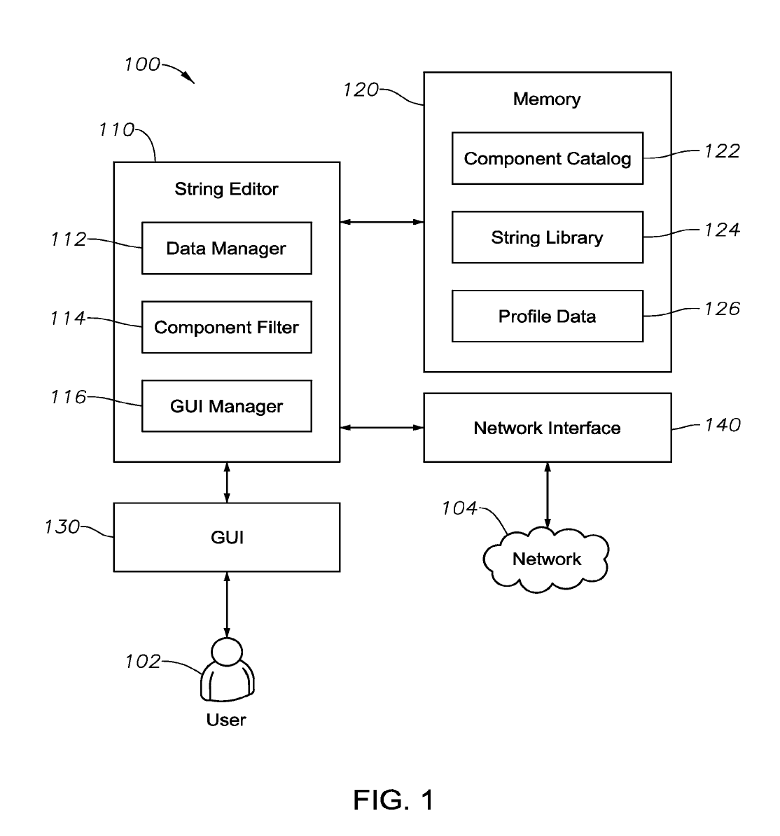

FIG. 1 illustrates a block diagram of an exemplary computer system 100 for aiding pipe string design based on existing string designs, according to an embodiment of the present disclosure. As shown in FIG. 1, system 100 includes a string design editor (or “string editor”) 110, a memory 120, a graphical user interface (GUI) 130, and a network interface 140. String editor 110 includes a data manager 112, a component filter 114, and a GUI manager 116. Memory 120 may be used to store a component catalog 122, a string library 124, and profile data 126. In an embodiment, string editor 110 and its components (data manager 112, a component filter 114, and GUI manager 116), memory 120, GUI 130, and network interface 140 may be communicatively coupled to one another via, for example, an internal bus of system 100.

In an embodiment, system 100 can be implemented using any type of computing device having one or more processors, a user input (for example, a mouse, QWERTY keyboard, touch-screen, a graphics tablet, or microphone), and a communications infrastructure capable of receiving and transmitting data over a network. Such a computing device can be, for example and without limitation, a mobile phone, a personal digital assistant (PDA), a tablet computer, a laptop computer, a desktop computer, a workstation, a cluster of computers, a set-top box, or other similar type of device capable of processing instructions and receiving and transmitting data to and from humans and other computing devices. Although only string editor 110, memory 120, GUI 130, and network interface 140 are shown in FIG. 1, it would be apparent to a person skilled in the relevant art that system 100 may include additional components, modules, and/or sub-components as desired for a particular implementation.

String editor 110 and its components (data manager 112, component filter 114, and GUI manager 116), can be implemented in software, firmware, hardware, or any combination thereof. Furthermore, embodiments of 3D data manager 112, component filter 114, and GUI manager 116, or portions thereof, can be implemented to run on any type of processing device including, but not limited to, a computer, workstation, embedded system, networked device, mobile device, or other type of processor or computer system capable of carrying out the functionality described herein.

As will be described in further detail below, memory 120 can be used to store information accessible by string editor 110 for implementing the pipe string design functionality of the present disclosure. Memory 120 may be any type of recording medium coupled to an integrated circuit that controls access to the recording medium. The recording medium can be, for example and without limitation, a semiconductor memory, a hard disk, or other similar type of memory or storage device. Moreover, memory 120 may be integrated within system 100 or an external device communicatively coupled to system 100. In some implementations, memory 120 may be a remote cloud-based storage location communicatively coupled to system 100 over a network 104 via network interface 140.

Network 104 can be any type of network or combination of networks used to communicate information between different computing devices. Network 104 can include, but is not limited to, a wired (e.g., Ethernet) or a wireless (e.g., Wi-Fi and 3G) network. In addition, network 104 can include, but is not limited to, a local area network, medium area network, and/or wide area network such as the Internet.

In an embodiment, string editor 110 uses GUI 130 to receive input from a user 102 via a user input device (not shown), e.g., a mouse, keyboard, microphone, or touch-screen display. As will be described in further detail below, GUI 130 may also be used to present information to user 102 based on the received input. The information may be presented to user 102 via a display (not shown) coupled to system 100. The display may be, for example and without limitation, a cathode ray tube (CRT) monitor, a liquid crystal display (LCD), or a touch-screen display, e.g., in the form of a capacitive touch-screen light emitting diode (LED) display. GUI 130 may be provided to user 102 by, for example, a string design application executable at system 100.

In an embodiment, GUI manager 116 receives input from user 102 via GUI 130 for a current string design being created within a first portion of GUI 130. The first portion of GUI 130 may be, for example, a dedicated design area of GUI 130 that enables user 102 to create a two-dimensional (2D) or three-dimensional (3D) graphical representation of the current string design. In an embodiment, GUI 130 enables user 102 to create the current string design by selecting different components to be added to the string design from a second portion, e.g., a dedicated component selection area, of GUI 130. GUI 130 may include, for example, a drag and drop interface that allows user 102 to select string components directly from a component selection area of the GUI and add (or “drop”) each selected component into the design area. The selectable string components may be represented as, for example, 2D or 3D graphical objects that user 102 can manipulate using a user input device (e.g., a mouse or other pointer device). This may include, for example, dragging and dropping the graphical objects for selected components from the component selection area to the current string design in the design area in addition to moving or reordering a graphical object for a component added to the current string design within the design area.

The 2D or 3D graphical representation of each component object displayed to user 102 via GUI 130 may be based on, for example, information stored within a component catalog 122. Such information may also include, for example, specifications for a set of component properties that uniquely identify the individual components that are available for use. The component properties may also be used to identify the individual components included within previously created string designs, as will be described in further detail below. In some implementations, the graphical component data may be stored separately from component catalog 122 within memory 120. The stored graphical component data may include, for example, one or more component identifiers that uniquely identifies the corresponding component within component catalog 122. In an embodiment, each component may be identified using a pair of identifiers or codes corresponding to a component category (or section type) associated with the component and a type of the component within the category. The category or section type of a component may represent, for example, a grouping of similar types of components. In an example, the section type for a component in a drill string design may be a drill bit section type and the component type may be any of various types of drill bits including, for example, a tri-cone bit, a polychristaline diamond bit, a coring bit, etc. In some implementations, each section type has a default component type, which may be used for a component added to a current string design if for example, the user has not specified a particular component type. While only component catalog 122 is shown in FIG. 1, it should be noted that additional component catalogs may be used. In an example, different component catalogs may be published by different component manufacturers or oil and gas field service providers. In some implementations, component catalog 122 and/or other component catalogs may be stored in a remote data store accessible to string editor 110 via network 104 and network interface 140.

In an embodiment, data manager 112 determines a string type for the current string design based on user input received by GUI manager 116 via GUI 130. The received user input may include, for example, an indication of a string type. The indication of the string type may be based on, for example, a selection by user 102 of a particular string type from a list of string types within a dropdown menu, popup list, or other type of selection control element displayed to user 102 via GUI 130. Alternatively, the string type may be determined automatically by data manager 112 based on, for example, the particular components added to the current string design. For example, certain components (e.g., drill bits) may be associated with only a specific string type (e.g., drill string). Thus, the string type for the current string design may be identified if at least one of the components associated with that string type has been added to the current design. Each type of string may have a different purpose or use applicable to a particular type of operation in the field of hydrocarbon exploration and recovery. Examples of different string types include, but are not limited to, drill strings, completion strings, rod strings, and workover strings.

Data manager 112 may obtain component data associated with previously created string designs of the string type selected or determined for the current string design. In an embodiment, the previously created string designs may be stored as part of string library 124 within memory 120. The string designs within string library 124 may have been previously created by user 102, other users, or a string design application developer, e.g., in the form of a editable string design model or template for users of the string design application. In an embodiment, each previously created string design within string library 124 may include a record of each component that was used to create the string design. For example, each previously created string design may be stored in association with component data corresponding to each component included within the string design. Data manager 112 may initiate a search to find the previously created string designs of a particular string type within string library 124. Data manager 112 may then obtain the component data by extracting it from the previously created string designs obtained from the search results. In an embodiment, data manager 112 may impose a date restriction to exclude string designs that were created prior to a predetermined date or that include relatively old components and that may no longer be considered relevant. In some implementations, string library 124 may be stored within, for example, a remote data store or database accessible to data manager 112 via network 104 by using network interface 140. Accordingly, data manager 112 may use network interface 140 to initiate a search via network 104 for previously created string designs of the specified string type within the database.

In an embodiment, component filter 114 may use the component data obtained by data manager 112 to generate a list of the individual components included within each of the previously created string designs. In an embodiment, component filter 114 identifies the individual components included within each string design based on a set of component properties that uniquely identify each component. The set of component properties for a component may include, for example and without limitation, a section type, a component type, physical dimensions (e.g., an outer and/or inner diameter), a weight, a type of material used to manufacture the component, and a grade of the material. As described above, the section type may denote, for example, the particular category or component group with which the component is associated, and the component type may represent the specific type of the component within the group. It should be appreciated that any number of component properties may be used to uniquely identify individual components of a particular type, as desired for a particular implementation.

Accordingly, the component data obtained for each previously created string design may include a set of values corresponding to the set of component properties for each component included within the previously created string design. The component data may include, for example, a record of each component including separate fields that correspond to the set of component properties (and respective values) that uniquely identify the specific component. Component filter 114 may identify each instance of the particular component within one or more of the previously created string designs by, for example, identifying a unique set of values corresponding to the set of component properties associated with that component.

In an embodiment, component filter 114 filters the generated list of components based on one or more filtering parameters related to the current string design and the previously created string designs. As noted above, examples of such filtering parameters may include, but are not limited to, component popularity (e.g., based on the number of instances that the component is included within one or more of the previously created string designs) and various operational constraints associated with the well or well site in which the current string design may be intended for use. For example, the type of well (e.g., vertical vs. horizontal well) to be drilled also may be used to filter out components that generally are not appropriate for that type of well. Other operational constraints may include, for example, various geographical and physical constraints or design parameters related to the particular well or well site. Geographical constraints/parameters may be related to, for example, component availability based on the particular site or geographic location of the well. Physical constraints/parameters may include, for example, the size or diameter of the well or borehole in which the current string design is intended for use. Thus, components that are too large to fit into the hole of the well also may be filtered out. This may be dependent upon the position of the component within the current string design as the size of the hole may vary according to its depth. In some implementations, component filter 114 by default may restrict the list to include only components that would fit into the diameter of the deepest hole section.

In an embodiment, the various design and component filtering parameters may be stored as profile data 126 within memory 120. Profile data 126 may be associated with the particular user 102 and therefore may be used to store user-specific design parameters including, for example, the particular geographic region or well site associated with the location of user 102. For example, component filter 114 may further restrict the generated list of components so as to include only components determined to be available within the particular geographic region or district corresponding to the location of user 102 and/or the well or drill site. Component filter 114 in this example may retrieve or request information from a database via network 104, which may be used to identify components that are located within the particular region or district and that are currently available for use.

As will be described in further detail below, the filtered list of components may be displayed to the user via GUI 130 in response to the user's selection of a component category or section type. In an embodiment, the displayed list of components may be dynamically updated based on changes detected to the current string design being created by the user via GUI 130. Such changes may include, for example, design changes made by the user to one or more of the components added to the current string design. Such design changes may include, for example and without limitation, a change in the order of components within the current string design or a change to one or more values associated with the properties of a component included within the current string design.

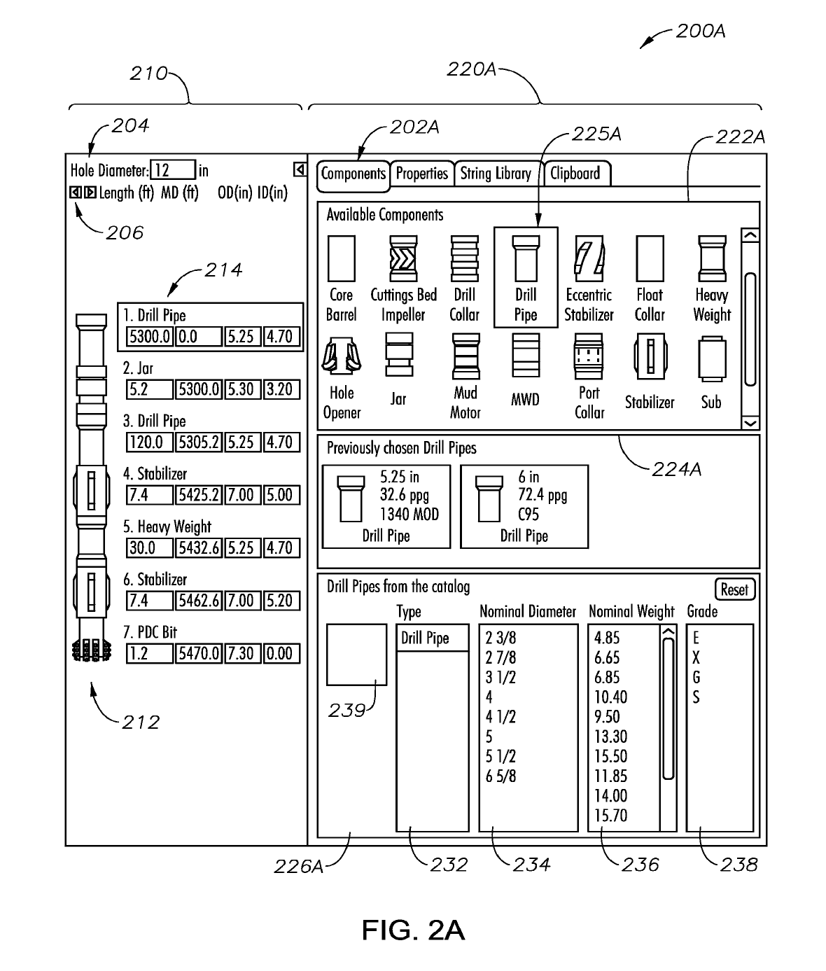

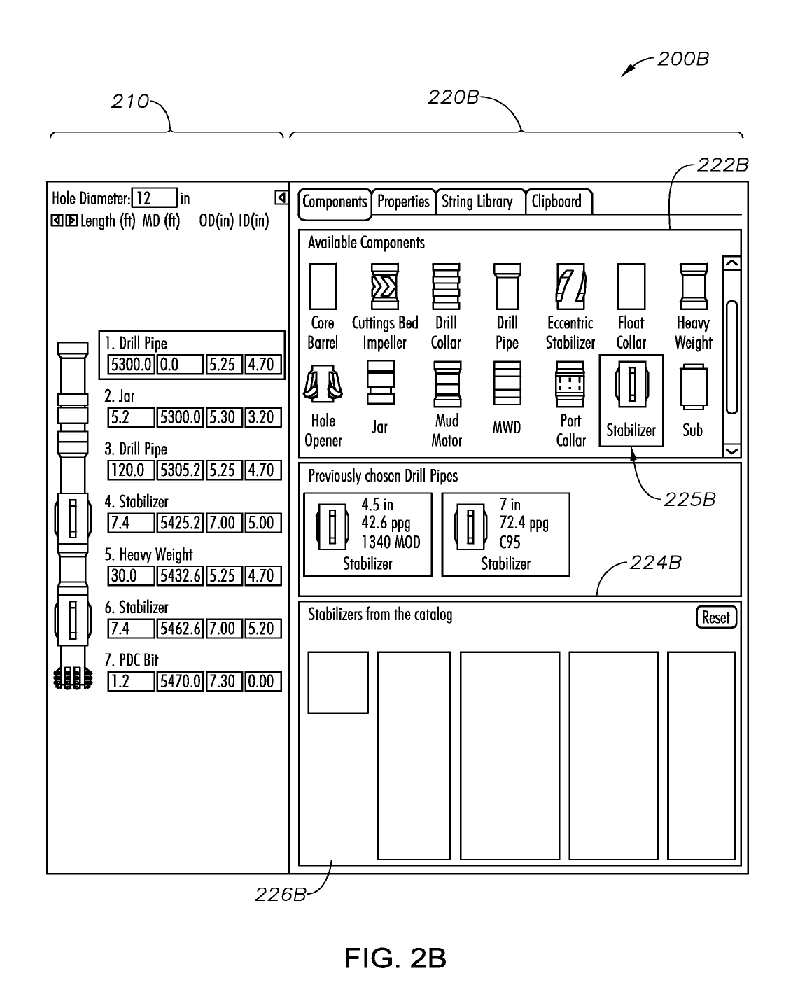

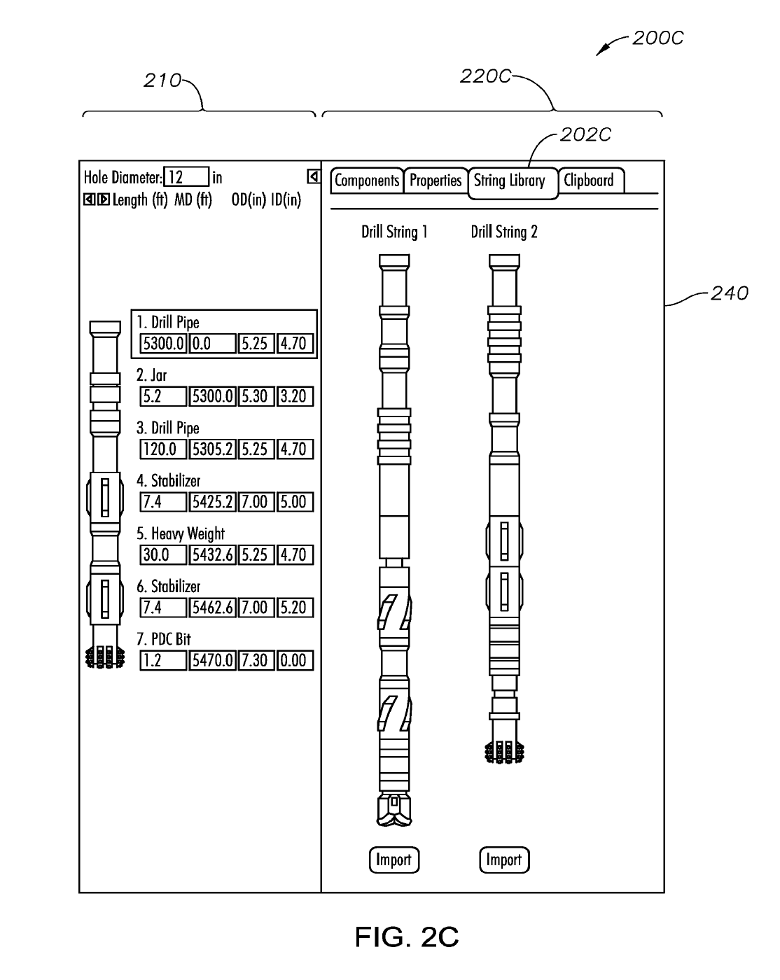

FIGS. 2A, 2B and 2C illustrate different views of an exemplary GUI (e.g., GUI 130 of FIG. 1, as described above) for designing pipe strings based on existing string designs. For discussion purposes, the exemplary GUI of FIGS. 2A, 2B, and 2C will be described using system 100 of FIG. 1, as described above, but is not intended to be limited thereto. As shown in FIG. 2A, a view 200A of the GUI includes a design area 210 and a component selection area 220A. Design area 210 may be a portion of the GUI in which a graphical representation of a current string design 212 may be displayed. Current string design 212 may be created by a user of the GUT by selecting components from the components selection area 220A and adding the selected components to current string design 212 displayed in design area 210. In an embodiment, components from the component selection area 220A may be added to the string by using a user input device (e.g., mouse or other pointer device) to select and drag components as desired to the string design area 210. The selected components may be added to either end of current string design 212 or inserted between existing components that were added previously. In some implementations, predefined types of user input (e.g., double-clicking on a component using a mouse or performing predefined touch gestures via a touch-screen display) may trigger default actions within the GUI. For example, double-clicking on a component displayed within component selection area 220A may add it to the end of current string design 212 within design area 210.

In an embodiment, the GUI may include error checking logic to verify that each component is ordered or positioned correctly within the current string design being created. For example, the GUI may check the order of each component as it is added by the user to current string design 212 within design area 210. The order information may be specific to the particular type of string and/or component. For example, in the design of a drill string, the error checking logic may verify that only one drill bit component is added to the string design and that it is added or positioned at the end of the string.

A set of component properties 214 and corresponding values also may be displayed in design area 210 alongside each component included within current string design 212. Various control elements 206 may also be displayed for viewing additional component properties that are not displayed in the current view. As shown in FIG. 2A, design area 212 also may include a control field 204 that enables the user to specify a diameter of the well or borehole for current string design 212. The size of the hole diameter specified by the user via control field 204 may be used as a filtering parameter to filter the components displayed within different sections of component selection area 220A, as will be described in further detail below.

In an embodiment, component selection area 220A may be divided into multiple sections. In the example shown in FIG. 2A, component selection area 220A is divided into three sections including: an available components section 222A for displaying a list of available component categories or section types; a previously chosen components section 224A for displaying a list of suggested component types based on the component category or section type selected in section 222A and an analysis of components that were added to previously created string designs; and a component catalog section 226A for displaying components of the selected type listed in one or more component catalogs (e.g., component catalog 122 of FIG. 1, as described above). While each portion (or area) and sub-portion (or section) is described below in reference to FIG. 2A, it should be appreciated that this description also applies to the corresponding portions (areas 210B and 220B) and sub-portions (sections 222B, 224B, and 226B) of view 200B of the GUI, as shown in FIG. 2B.

As shown in FIG. 2A, section 222A may be used to display a 2D or 3D graphical representation of each of the basic component categories or section types available for use with current string design 212. It should be appreciated that embodiments are not intended to be limited to the component categories or section types shown in FIG. 2A and that additional categories may be included. In an embodiment, the available component categories displayed in section 222A may include only those appropriate to the type of string being designed. For example, if current string design 212 is for a completion string rather than a drill string, only component categories that are appropriate for well completion may be displayed within section 222A, while component categories that are specific to drill strings (e.g., drill bits and stabilizer components) may be excluded. While not shown in FIG. 2A, the GUI may include a control element (e.g., a menu or list control) that enables the user to specify the particular string type for current string design 212 by selecting the string type from a list of known or commonly used string types, as described above.

The selection of a particular component category via section 222A may control the content displayed in sections 224A and 226A. For example, in FIG. 2A, the selection of a drill pipe category 225A within section 222A causes sections 224A and 226A to display suggested types of drill pipes and options for selecting a particular type of drill pipe from one or more component catalogs. Similarly, in FIG. 2B, sections 224B and 226B are updated to display different stabilizer component options based on a selection of a stabilizer category 225B within section 222B. As shown in FIG. 2B, section 226B may be empty if there are no components matching the component category and/or other design parameters associated with current string design 212. Such design parameters (e.g., hole diameter) may be specified by, for example, the user via a menu option or control field (e.g., control field 204) of the GUI. In an example, the user may have specified a preference via the GUI, e.g., via a menu option or user setting within a preference panel (not shown), for limiting the available catalog options to only component catalogs associated with a particular component manufacturer. Thus, catalog section 226B of FIG. 2B may be empty if the manufacturer-specific component catalog does not include any stabilizer components.

In an embodiment, the component selection area of the GUI shown in FIGS. 2A-2C may include a set of tabs 202 corresponding to different functions related to the current string design or previously created string designs. The selection of different tabs by the user may cause the contents of the component selection area to change across different views of the GUI. For example, the component selection area 220A, as shown in view 200A of FIG. 2A may be displayed as a result of selecting a components tab 202A. However, FIG. 2C shows a different view 200C of the GUI based on the selection of a string library tab 202C. As shown in view 200C of FIG. 2C, a component selection area 220C is used to display a content screen 240 of previously created string designs from a string library (e.g., string library 124 of FIG. 1, as described above). The previously created string designs that are displayed may be filtered based on the string type of the current string design. While only two string designs for drill strings are shown in FIG. 2C, it should be noted that embodiments are not limited thereto and that additional string designs may be displayed for other string types, based on the current string design. Also, as shown in FIG. 2C, the string library content screen 240 may include options to import a previously created string design for creating the current string design within the design area 210C. The user may have the option to import a previously created string design as a whole or one or more selected components thereof. In an example the selected string design or components may be automatically added to the design area 210. In this way, the imported string design and/or components thereof may serve as, for example, a starting point for the user to customize or modify in creating the current string design. Additional tabs that may be provided include, for example and without limitation, a component properties tab for displaying a complete list of component properties associated with a selected component. For example, a particular component may have hundreds or thousands of different properties that may be defined. A clipboard tab may also be provided, for example, to enable the user to temporarily store selected components of interest that later may be added to the current string design.

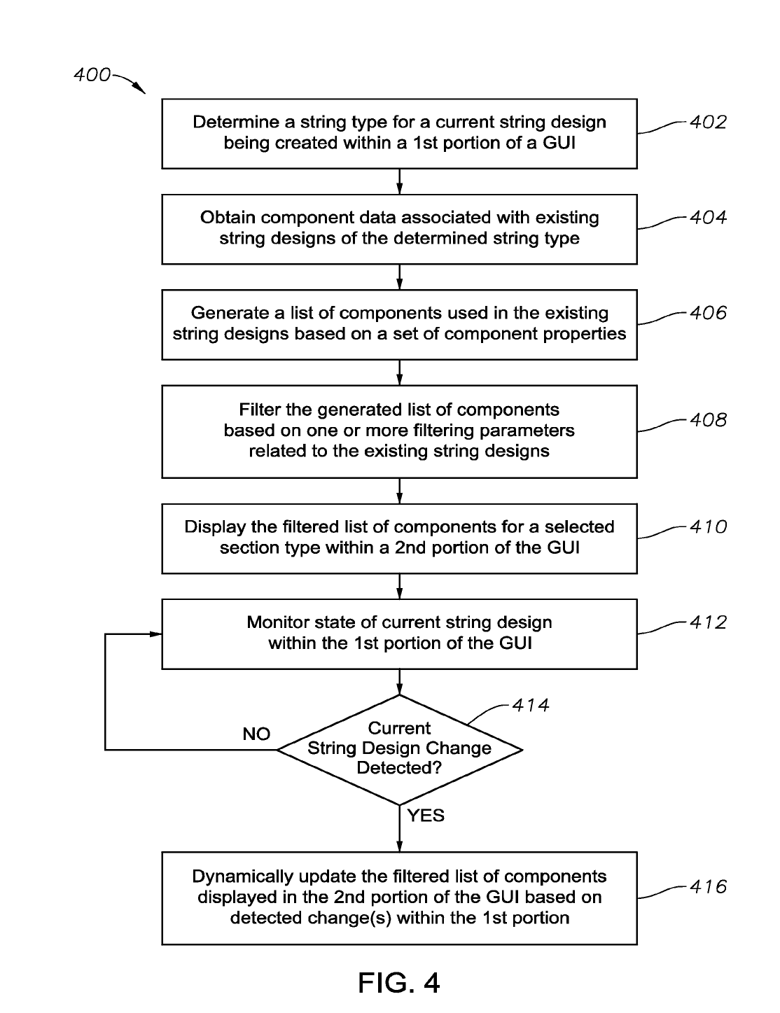

Referring back to view 200A of FIG. 2A, section 224A may be used to display a list of suggested components of the type selected in section 222A, as described above. The list may include specific components or different versions of the selected component category, which have been determined to be the most likely options for the user based on components previously chosen by the user or other users for previously created string designs. This list may be generated based on analysis of strings previously built and components previously added to the strings. This list may also be filtered so that components that have been determined not to fit in the hole for which the current string is being designed are not displayed. The determination may be based on the size of the hole diameter specified in control field 204. The list generation and filtering process for the component suggestions displayed in section 224A will be described in further detail below with respect to method 400 of FIG. 4.

Section 226A of the component selection area 220A may be used to present the user with available components from one or more previously defined component catalogs (e.g., component catalog 122 of FIG. 1, as described above) based on the component category selected by the user via section 222A. Similar to the list of previously chosen or suggested components displayed in section 224A, the components catalog may be filtered based on the hole diameter specified in control field 204 so that components that would not fit in the hole for which the current string is being designed are not displayed.

As shown in the example of FIG. 2A, section 226A may be used to display a list of selectable values for various component properties that uniquely identify or distinguish individual or specific components within one or more catalogs, based on the category selected in section 222A. Each of the selectable values may be displayed as a separate row within a column corresponding to one of the component properties. As shown in FIG. 2A, the displayed component properties and selectable values may include a component category or section type 232, a component diameter 234, a component weight 236, and a material grade 238. It should be noted that other component properties (e.g., other component dimensions) may also be provided for filtering the component catalog. It should also be noted that more or fewer component properties may be displayed in section 226A than those shown in FIG. 2A.

As will be described in further detail below, in order to filter the available components within the catalog(s), the user may select a row corresponding to a value within each list of values displayed for a component property column. Each value may correspond to a different catalog item based on the particular component property. Once a catalog item has been selected for each component property, a component image 239 may be displayed. The displayed image 239 may be, for example, a 2D or 3D graphical object representing the component, which can be selected by the user and added to the current string design, e.g., by using an input device to drag and drop or double-click the graphical component object that is displayed.

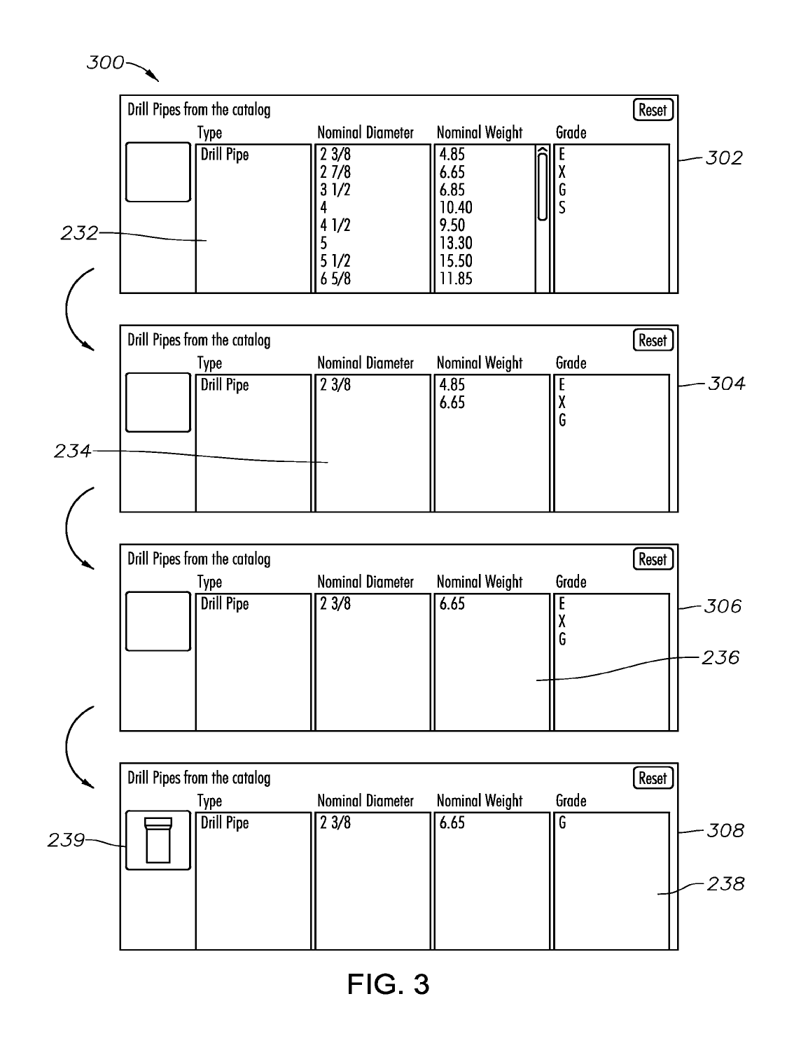

FIG. 3 illustrates an exemplary user process 300 for filtering components via component catalog section 226A of the GUI, as shown in view 200A of FIG. 2A. In step 302, the user selects the component category or section type 232 (e.g., a drill pipe). In step 304, a value for diameter 234 of the desired component is selected. Similarly, values for the component's weight 236 and material grade 238 are selected in steps 306 and 308, respectively. Once the last distinguishing component property is selected by the user, the image 239 of the catalog-listed component having the properties selected by the user may be displayed. As described above, the user may be able to add the component to the current string design by dragging and dropping the image 239 (or graphical component object) from the catalog section to the design area 210.

FIG. 4 is a process flowchart of an exemplary method 400 for filtering string components for a pipe string design based on existing string designs. The existing string designs may include the current string design being created and one or more string designs created previously, e.g., by a user or other users of a string design application, as described above. As shown in FIG. 4, method 400 includes steps 402, 404, 406, 408, 410, 412, 414, and 416. For discussion purposes, method 400 will be described using computer system 100 of FIG. 1, as described above. However, method 400 is not intended to be limited thereto. Also, for discussion purposes, method 400 will be described in reference to view 200A of the exemplary GUI, as shown in FIG. 2A and described above, but method 400 is not intended to be limited thereto. In an example, the steps of method 400 may be performed to filter the list of previously chosen or suggested components displayed in section 224A of the component selection area 220A of FIG. 2A, as described above.

Method 402 begins in step 402, which includes determining a string type for a current string design being created within a first portion (e.g., design area 210 of FIG. 2A) of a GUI. The first portion of the GUI may be, for example, a graphical design area that enables the user to create the current string design using string components selected from a second portion (e.g., component selection area 220A of FIG. 2A) of the GUI. In an embodiment, the string type may be determined based on user input received via the GUI. As described above, the user input may include an indication of the string type based on, for example, the user's selection of a string type from an options list of supported string types displayed to the user via the GUI.

In step 404, component data associated with the existing string designs based on the determined string type. The component data may be stored, for example, in association with previously created string designs within a string library (e.g., string library 124 of FIG. 1), as described above. In an embodiment, the component data may be obtained by initiating a search of the string library for previously created string designs of the determined string type, and extracting the component data corresponding to each of the plurality of components of each previously created string design obtained as a result of the search. Steps 402 and 404 may be performed by, for example, data manager 112 of system 100 of FIG. 1, as described above.

In step 406, a list of the distinct or individual components used in the existing string designs may be generated based on a set of component properties that uniquely identify individual components of each existing string design. As described above, the set of component properties may include, but are not limited to, a section type, a component type, an outer diameter, an inner diameter, a weight, a material type, and a material grade. Accordingly, the component data obtained in step 406 may include, for example, a predefined set of values corresponding to the set of component properties. In an embodiment, step 406 may include identifying each individual component and tracking the number of times that the same component appears within the current string design and/or any of the previously created string designs. For example, the same component may be tracked by matching different instances of the same set of component properties across one or more existing string designs.

In step 408, the generated list of components may be filtered based on one or more filtering parameters related to the current string design and the previously created string designs. The one or more filtering parameters may include, for example and without limitation: component popularity based on the number of instances that each component appears within one or more of the previously created string designs, as described above; the type of well (e.g., vertical vs. horizontal well) in which the current string design is intended for use; physical constraints associated with the size of the well or borehole (e.g., based on the diameter specified in control field 204 of FIG. 2A, as described above); one or more operational constraints related to the particular geographic location of the well site, such as the type of formation (e.g., shale vs. deep water), other geological factors (e.g., subsurface operating temperatures); and user-specific design constraints or parameters (e.g., user-specified preference for components from a specific manufacturer or catalog).

In some implementations, the filtered list may be sorted and/or prioritized. In an example, the list may be sorted according to component popularity so that components included more often within the previously created string designs are assigned a relatively higher priority than other components in the list. In a further example, components that have already been added to the current string design may be automatically assigned a relatively higher priority than components that appear only within the previously created string designs. In this example, the components within the current string design may be ranked according to when each component was added to the current string design such that the most recently added component has the highest priority. Accordingly, the component rankings and priorities may be dynamically updated as additional components are added to the current string design or as other changes are made to the design, as will be described in further detail below. In yet a further example, components that are included within previously created string designs by the same user may be assigned relatively higher priority than other previous string designs created by other users. Steps 406 and 408 may be performed by, for example, component filter 114 of system 100 of FIG. 1, as described above.

In step 410, the filtered list of components for a selected component category or section type is displayed within second portion (e.g., component selection area 220A of FIG. 2A) of the GUI. As described above, the filtered list of components may be displayed as 2D or 3D graphical objects that may be selected by the user and added to the current string design within the first portion (e.g., design area 210 of FIG. 2A) of the GUI. In an example, the components within the filtered list may be ranked according to their assigned priorities, as described above. Thus, in some implementations, the components in the filtered list may be displayed according to their rank so that the component that is ranked first (and has the highest priority) is displayed before other components.

In step 412, the state of the current string design within the first portion of the GUI is monitored. In steps 414 and 416, the filtered list of components displayed in the second portion (e.g., component selection area 220A) of the GUI may be dynamically updated in response to a change detected with respect to the current string design within the first portion (e.g., design area 210) of the GUI. The detected change may be, for example, a change made to one or more of the components added to the current string design. Such a change may include, for example and without limitation, the addition of a component to the current string design, the removal of a component, or a change to the order or other characteristic (e.g., values of one or more component properties) of one or more components of the current string design. The dynamic updating in step 416 also may include, for example, dynamically updating the component rankings and priorities, as described above. Steps 410, 412, 414, and 416 may be performed by, for example, a combination of component filter 114 and GUI manager 116 of system 100 of FIG. 1, as described above.

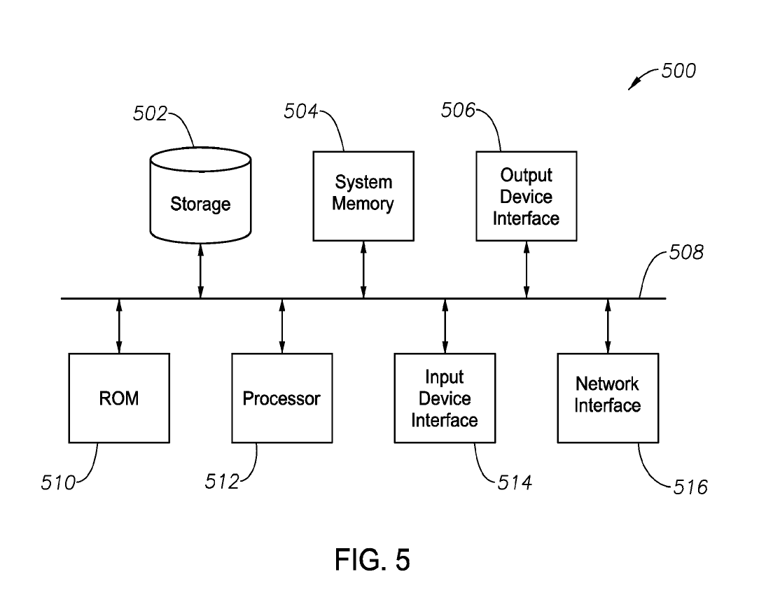

FIG. 5 is a block diagram of an exemplary computer system 500 in which embodiments may be implemented. System 500 can be a computer, phone, PDA, or any other type of electronic device. Such an electronic device includes various types of computer readable media and interfaces for various other types of computer readable media. As shown in FIG. 5, system 500 includes a permanent storage device 502, a system memory 504, an output device interface 506, a system communications bus 508, a read-only memory (ROM) 510, processing unit(s) 512, an input device interface 514, and a network interface 516.

Bus 508 collectively represents all system, peripheral, and chipset buses that communicatively connect the numerous internal devices of system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of system 500. Permanent storage device 502, on the other hand, is a read-and-write memory device. This device is a non-volatile memory unit that stores instructions and data even when system 500 is off Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, and/or ROM 510. For example, the various memory units include instructions for computer aided pipe string design based on existing string designs in accordance with some implementations. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the system 500. Input devices used with input device interface 514 include, for example, alphanumeric, QWERTY, or T9 keyboards, microphones, and pointing devices (also called “cursor control devices”). Output device interfaces 506 enables, for example, the display of images generated by the system 500. Output devices used with output device interface 506 include, for example, printers and display devices, such as cathode ray tubes (CRT) or liquid crystal displays (LCD). Some implementations include devices such as a touchscreen that functions as both input and output devices. It should be appreciated that embodiments of the present disclosure may be implemented using a computer including any of various types of input and output devices for enabling interaction with a user. Such interaction may include feedback to or from the user in different forms of sensory feedback including, but not limited to, visual feedback, auditory feedback, or tactile feedback. Further, input from the user can be received in any form including, but not limited to, acoustic, speech, or tactile input. Additionally, interaction with the user may include transmitting and receiving different types of information, e.g., in the form of documents, to and from the user via the above-described interfaces.

Also, as shown in FIG. 5, bus 508 also couples system 500 to a public or private network (not shown) or combination of networks through a network interface 516. Such a network may include, for example, a local area network (“LAN”), such as an Intranet, or a wide area network (“WAN”), such as the Internet. Any or all components of system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself. Accordingly, the steps of method 400 of FIG. 4, as described above, may be implemented using system 500 or any computer system having processing circuitry or a computer program product including instructions stored therein, which, when executed by at least one processor, causes the processor to perform functions relating to these methods.

As used in this specification and any claims of this application, the terms “computer”, “server”, “processor”, and “memory” all refer to electronic or other technological devices. These terms exclude people or groups of people. As used herein, the terms “computer readable medium” and “computer readable media” refer generally to tangible, physical, and non-transitory electronic storage mediums that store information in a form that is readable by a computer.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., a web page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The foregoing methods and systems disclosed herein are particularly useful in computer aided design of pipe strings based on existing string designs. In one embodiment of the present disclosure, a computer-implemented method for aiding pipe string design includes: determining a string type for a current string design based on input received from a user via a graphical user interface (GUI), where the GUI enables the user to create the current string design within a graphical design area of the GUI using string components selected from a component selection area of the GUI; obtaining component data associated with previously created string designs of the determined string type, where each string design includes a plurality of components; generating a list of components included within the previously created string designs based on the obtained component data and a set of component properties that uniquely identify individual components of the previously created string designs; filtering the generated list of components based on one or more filtering parameters related to the current string design and the previously created string designs; and displaying the filtered list of components for a selected component category within the component selection area of the GUI.

In a further embodiment, the string type is a completion string, a rod string, or a workover string. In yet a further embodiment, the above-described computer-implemented method further includes detecting a change to the current string design within the graphical design area of the GUI and dynamically updating the displayed list of components based on the detected change. In yet a further embodiment, obtaining the component data in the above-described method includes initiating a search of a string library for the previously created string designs of the determined string type and extracting the component data corresponding to each of the plurality of components of each previously created string design obtained as a result of the search. In yet a further embodiment, the set of component properties include a section type, a component type, an outer diameter, an inner diameter, a weight, a material type, and a material grade, and the component data associated with the previously created string designs includes a set of values corresponding to the set of component properties. In yet a further embodiment, the one or more filtering parameters include a component popularity based on a number of instances of each component within one or more of the previously created string designs. In yet a further embodiment, the one or more filtering parameters include a type, a geographic location, and a physical size of a well in which the current string design will be used. In yet a further embodiment, the component selection area is divided into a plurality of sections including a first section for displaying available component categories and enabling the user to select one of the displayed component categories, a second section for displaying a list of suggested components of the component category selected by the user in the first section, and a third section for displaying component selection options for one or more catalogs of components of the selected component category.

In another embodiment of the present disclosure, a system for aiding pipe string design comprises at least one processor and a memory including instructions stored therein, which when executed by the processor, cause the processor to perform functions including functions to: determine a string type for a current string design based on input received from a user via a graphical user interface (GUI), the GUI enabling the user to create the current string design within a graphical design area of the GUI using string components selected from a component selection area of the GUI; obtain component data associated with previously created string designs of the determined string type, each string design including a plurality of components; generate a list of components included within the previously created string designs based on the obtained component data and a set of component properties that uniquely identify individual components of the previously created string designs; filter the generated list of components based on one or more filtering parameters related to the current string design and the previously created string designs; and display the filtered list of components for a selected component category within the component selection area of the GUI.

In yet another embodiment of the present disclosure, a computer-readable storage medium having instructions stored therein, which when executed by a processor cause the processor to execute functions, including functions to: determine a string type for a current string design based on input received from a user via a graphical user interface (GUI), the GUI enabling the user to create the current string design within a graphical design area of the GUI using string components selected from a component selection area of the GUI; obtain component data associated with previously created string designs of the determined string type, each string design including a plurality of components; generate a list of components included within the previously created string designs based on the obtained component data and a set of component properties that uniquely identify individual components of the previously created string designs; filter the generated list of components based on one or more filtering parameters related to the current string design and the previously created string designs; and display the filtered list of components for a selected component category within the component selection area of the GUI.

Furthermore, the exemplary methodologies described herein may be implemented by a system including processing circuitry or a computer program product including instructions which, when executed by at least one processor, causes the processor to perform any of the methodology described herein.

Although various embodiments and methodologies have been shown and described, the present disclosure is not limited to such embodiments and methodologies and will be understood to include all modifications and variations as would be apparent to one skilled in the art. Therefore, it should be understood that this disclosure is not intended to be limited to the particular forms disclosed. Rather, the intention is to cover all modifications, equivalents and alternatives falling within the spirit and scope of the disclosure as defined by the appended claims.

What is claimed is:

1. A computer-implemented method for aiding pipe string design, the method comprising:
determining a string type for a current string design based on input received from a user via a graphical user interface (GUI), the GUI enabling the user to create the current string design within a graphical design area of the GUI using string components selected from a component selection area of the GUI;
obtaining component data associated with previously created string designs of the determined string type, each string design including a plurality of components;
generating a list of components included within the previously created string designs based on the obtained component data and a set of component properties that uniquely identify individual components of the previously created string designs;
filtering the generated list of components based on one or more filtering parameters related to the current string design and the previously created string designs; and
displaying the filtered list of components for a selected component category within the component selection area of the GUI.

2. The method of claim 1, wherein the string type is a completion string, a rod string, or a workover string.

3. The method of claim 1, further comprising:
detecting a change to the current string design within the graphical design area of the GUI; and
dynamically updating the displayed list of components based on the detected change.

4. The method of claim 1, wherein obtaining the component data comprises:
initiating a search of a string library for the previously created string designs of the determined string type; and
extracting the component data corresponding to each of the plurality of components of each previously created string design obtained as a result of the search.

5. The method of claim 1, wherein the set of component properties include a section type, a component type, an outer diameter, an inner diameter, a weight, a material type, and a material grade, and the component data associated with the previously created string designs includes a set of values corresponding to the set of component properties.

6. The method of claim 1, wherein the one or more filtering parameters include a component popularity based on a number of instances of each component within one or more of the previously created string designs.

7. The method of claim 1, wherein the one or more filtering parameters include a type, a geographic location, and a physical size of a well in which the current string design will be used.

8. The method of claim 1, wherein the component selection area is divided into a plurality of sections including a first section for displaying available component categories and enabling the user to select one of the displayed component categories, a second section for displaying a list of suggested components of the component category selected by the user in the first section, and a third section for displaying component selection options for one or more catalogs of components of the selected component category.

9. A system for aiding pipe string design, the system comprising:
at least one processor; and
a memory including instructions stored therein, which when executed by the processor, cause the processor to perform functions including functions to:
determine a string type for a current string design based on input received from a user via a graphical user interface (GUI), the GUI enabling the user to create the current string design within a graphical design area of the GUI using string components selected from a component selection area of the GUI;
obtain component data associated with previously created string designs of the determined string type, each string design including a plurality of components;
generate a list of components included within the previously created string designs based on the obtained component data and a set of component properties that uniquely identify individual components of the previously created string designs;
filter the generated list of components based on one or more filtering parameters related to the current string design and the previously created string designs; and
display the filtered list of components for a selected component category within the component selection area of the GUI.

10. The system of claim 9, wherein the string type is a completion string, a rod string, or a workover string.

11. The system of claim 9, wherein the functions performed by the processor further include functions to:
detect a change to the current string design within the graphical design area of the GUI; and
dynamically update the displayed list of components based on the detected change.

12. The system of claim 9, wherein the functions performed by the processor include functions to:
initiate a search of a string library for the previously created string designs of the determined string type; and
extract the component data corresponding to each of the plurality of components of each previously created string design obtained as a result of the search.

13. The system of claim 9, wherein the set of component properties include a section type, a component type, an outer diameter, an inner diameter, a weight, a material type, and a material grade, and the component data associated with the previously created string designs includes a set of values corresponding to the set of component properties.

14. The system of claim 9, wherein the one or more filtering parameters include a component popularity based on a number of instances of each component within one or more of the previously created string designs.

15. The system of claim 9, wherein the one or more filtering parameters include a type, a geographic location, and a physical size of a well in which the current string design will be used.

16. The system of claim 9, wherein the component selection area is divided into a plurality of sections including a first section for displaying available component categories and enabling the user to select one of the displayed component categories, a second section for displaying a list of suggested components of the component category selected by the user in the first section, and a third section for displaying component selection options for one or more catalogs of components of the selected component category.

17. A computer-readable storage medium having instructions stored therein, which when executed by a processor cause the processor to execute functions, including functions to:
determine a string type for a current string design based on input received from a user via a graphical user interface (GUI), the GUI enabling the user to create the current string design within a graphical design area of the GUI using string components selected from a component selection area of the GUI;
obtain component data associated with previously created string designs of the determined string type, each string design including a plurality of components;
generate a list of components included within the previously created string designs based on the obtained component data and a set of component properties that uniquely identify individual components of the previously created string designs;
filter the generated list of components based on one or more filtering parameters related to the current string design and the previously created string designs; and
display the filtered list of components for a selected component category within the component selection area of the GUI.

18. The computer-readable storage medium of claim 17, wherein the functions performed by the processor further include functions to:
detect a change to the current string design within the graphical design area of the GUI; and
dynamically update the displayed list of components based on the detected change.

19. The computer-readable storage medium of claim 17, wherein the functions performed by the processor include functions to:
initiate a search of a string library for the previously created string designs of the determined string type; and
extract the component data corresponding to each of the plurality of components of each previously created string design obtained as a result of the search.

20. The computer-readable storage medium of claim 17, wherein the one or more filtering parameters include a component popularity based on a number of instances of each component within one or more of the previously created string designs.
